(19) United States
(12) Patent Application Publication
(10) Pub. No.: US 2019/0225829 A1
(43) Pub. Date: Jul. 25, 2019

(54) SURFACE STAINING COMPOSITION AND METHOD

(71) Applicant: Mikle I. Cam, Salem, OR (US)

(72) Inventor: Mikle I. Cam, Salem, OR (US)

(21) Appl. No.: 16/254,180

(22) Filed: Jan. 22, 2019

Related U.S. Application Data
(60) Provisional application No. 62/619,616, filed on Jan. 19, 2018.

(51) Int. Cl. C09D 15/00; C09D 5/02; C09D 133/00; B27K 5/02

(52) U.S. Cl. CPC C09D 15/00; B27K 5/02; C09D 133/00; C09D 5/021

(57) ABSTRACT

A surface staining composition; the surface staining composition includes a mixture with a suitably blended ratio of 10 parts acrylic lacquer to 1 part stain base. The stain base further includes at least one pigment additive for color matching a surface-color. The present invention is suitably desired for finishing new and different wood species to match existing and/or difficult wood staining projects. A method for shading a finish coat to a semi-transparent color is also disclosed herein.

### CROSS-REFERENCE TO RELATED APPLICATION(S)

The present application is related to and claims priority to U.S. Provisional Patent Application No. 62/619,616 filed Jan. 19, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of surface treatments and finishes of existing art and more specifically relates to surface staining treatments on different types of wood.

### RELATED ART

When staining wood, it can be difficult for individuals, professionals, and do-it-yourselfers to match different wood species to a desired color. There can be blotchiness, variations in color between open and closed grains, color variations on different types of wood, and difficulty matching aged lacquers. Color variation is especially common when applying two or three coats. A more effective application method and composition is desired.

U.S. Pub. No. 2008/0275168 to John Friederich Schierlmann relates to a stain for interior and exterior decorative wood substrates. The described stain for interior and exterior decorative wood substrates includes a solvent or water based coating composition comprising a one step stain and topcoat. The solvent based one-step composition comprises at least one of an alkyd or oil modified urethane polymer, one or more surfactants to provide smooth uniform coatings and at least one micro pigment particle of less than about 2 μm. The water-based composition comprises at least one of self-crosslinking acrylic, oxidizable polyurethane dispersion and polyurethane dispersion polymers, at least one coalescing aid, one or more cross-linker to enhance the tensile strength of the cured coating and improve its chemical resistance, a thickener to increase viscosity of the dispersions, one or more surfactants to provide smooth uniform coatings and at least one micro pigment particle of less than 2 μm. The present invention is further directed to a water based stain for coloring wood.

### SUMMARY OF THE INVENTION

In view of the foregoing disadvantages inherent in the known wood treating and finishing art, the present disclosure provides a novel surface staining composition and method. The general purpose of the present disclosure, which will be described subsequently in greater detail, is to provide a surface staining composition and method to improve the application and matching of different wood species to a desired color.

A surface staining composition is disclosed herein. The surface staining composition comprises a mixture including an admixture of 10 parts acrylic lacquer and 1 part stain base. The stain base may comprise at least one pigment additive, and the at least one pigment color-matches a surface-color of the surface. The mixture can be applied to a surface to provide a clear protective finish.

According to another embodiment, a method for shading a finish coat to a semi-transparent color is also disclosed herein. The method includes a providing the surface staining composition comprising the mixture including the admixture of 10 parts acrylic lacquer and 1 part stain base. The method further includes the steps of preparing a surface for application, spraying the surface with the surface staining composition, and applying at least one layer of the surface staining composition.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a surface staining composition and method, constructed and operative according to the teachings of the present disclosure.

FIG. 1 is a perspective view of the surface staining composition according to an embodiment of the disclosure.

FIG. 2 is a cut-away perspective view of an aerosol can containing the surface staining composition of FIG. 1, according to an embodiment of the present disclosure.

FIG. 3 is a perspective view of the aerosol can of FIG. 1, according to an embodiment of the present disclosure.

FIG. 4 is a diagram illustrating the surface staining composition of FIG. 1, according to an embodiment of the present disclosure.

FIG. 5 is a flow diagram illustrating a method for shading a finish coat to a semi-transparent color, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a surface staining treatment and more particularly to a surface staining composition and method as used to improve the matching of different wood species to a desired color.

Generally, the present invention provides a combination of wood stain and clear protective finish in an aerosol can. It allows contractors and homeowners to easily match different wood species to a desired color. It offers an effective method for shading a finish coat to a semi-transparent color. As formulated, the composition creates a more uniformed color and reduces blotchiness and color variations when applying multiple coats. The present composition and method may enable users to easily achieve their desired color on different types of wood.

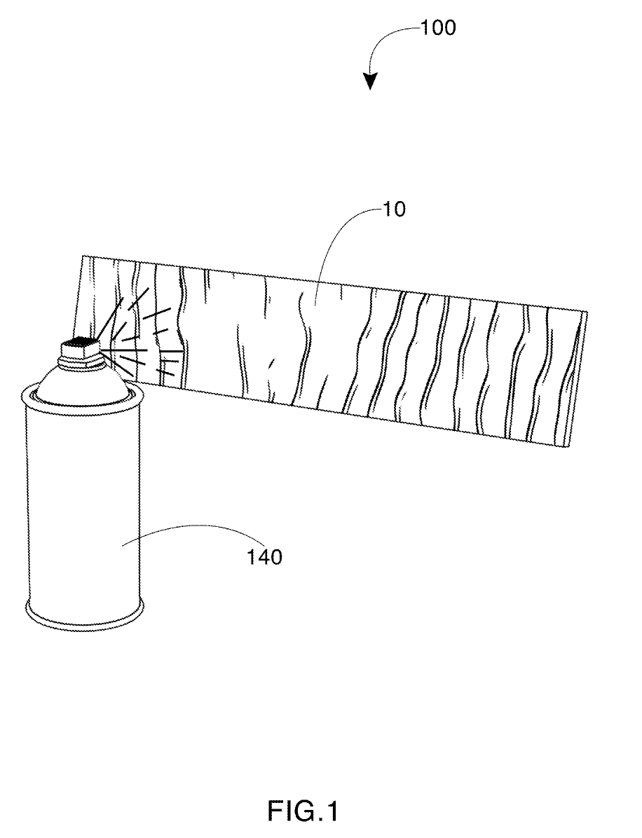

Referring now more specifically to the drawings by numerals of reference, there is shown in FIGS. 1-4, various views of a surface staining composition 100.

FIG. 1 shows a surface staining composition 100 according to an embodiment of the present disclosure. Here, the surface staining composition 100 may be beneficial for application to a surface 10. The first aspect of this invention provides the surface staining composition 100 comprising a mixture including an admixture of 10 parts acrylic lacquer 110 and 1 (one) part stain base 120. The stain base 120 may comprise at least one pigment additive 130, and the at least one pigment 130 color-matches a surface-color of the surface 10. The mixture can be applied to the surface 10 to provide a clear protective finish. As used herein, the surface 10 comprises of wood.

In a preferred embodiment, the mixture may be atomizable and provided in an aerosol can 140. The mixture may be applied via spraying to the surface 10. Spraying of the mixture is desirable as it can provide a uniform and even color when the mixture is applied to the surface 10. The surface staining composition 100 may be applied in layers with the aerosol can 140 to achieve the surface-color desired. The surface staining composition 100 when applied, adheres to, and forms a continuous coat on the surface 10 in which the surface staining composition 100 is applied.

According to one embodiment, the surface staining composition 100 may be arranged as a kit 105. In particular, the surface staining composition 100 may further include a set of instructions 107. The instructions 107 may detail functional relationships in relation to the structure of the surface staining composition 100 such that the surface staining composition 100 can be used, maintained, or the like, in a preferred manner.

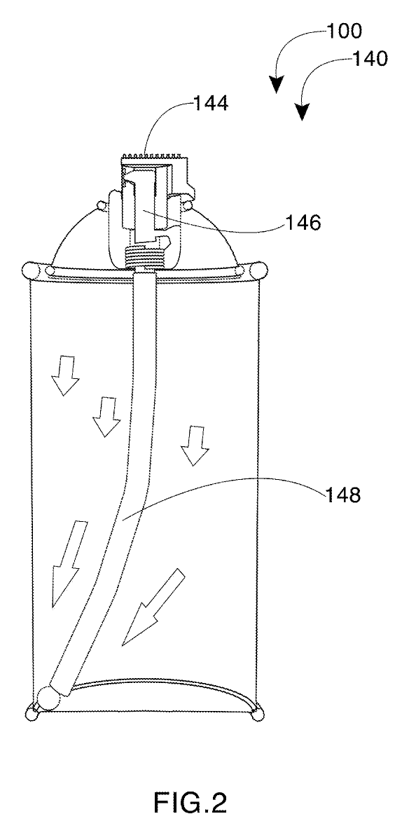

FIG. 2 shows the aerosol can 140 containing the surface staining composition 100 of FIG. 1, according to an embodiment of the present disclosure. As above, the surface staining composition 100 may comprise the mixture including the admixture of 10 parts acrylic lacquer 110 and 1 part stain base 120. The stain base 120 may comprise the at least one pigment additive 130, and the at least one pigment 130 color-matches the surface-color of the surface 10. The mixture may be atomizable and provided in the aerosol can 140. The aerosol can 140 may include an actuator 144, a valve 146, and a dip tube 148 configured to be used in combination for distributing the mixture evenly across the surface 10 as emitted.

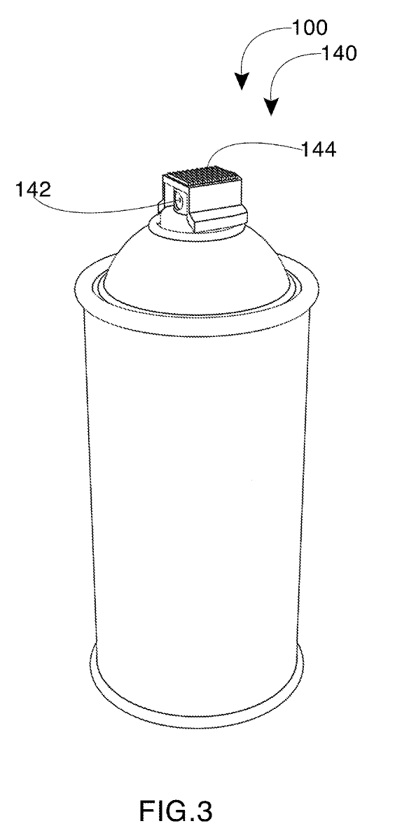

FIG. 3 is a perspective view of the aerosol can 140 of FIG. 1, according to an embodiment of the present disclosure. The mixture may be provided as a liquid. The liquid may be distributed in an aerosol mist of liquid-particles via a spray-tip 142 on the aerosol can 140. To use, the actuator 144 may be pressed thereby releasing the aerosol mist. The aerosol mist may be desired for evenly spreading the surface staining composition 100 on the surface 10 (as shown in FIG. 1).

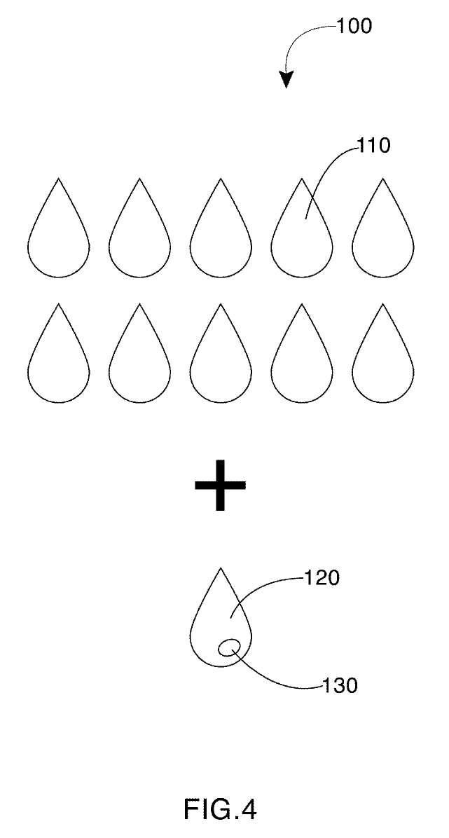

FIG. 4 is a diagram illustrating the surface staining composition 100 of FIG. 1, according to an embodiment of the present disclosure. As described above, the mixture may comprise an approximately 1 to 10 ratio of the stain base 120 to the acrylic lacquer 110. The mixture is suitably mixed such that it is semi-transparent when applied to the surface 10. When applying one or more layers, the buildup of shaded lacquer creates a more uniform color and reduces common issues such as blotchiness and color variations. The surface staining composition 100 may further comprise one of a thickener, a binder, a thinner, or a combination thereof.

The acrylic lacquer 110 may be a finishing agent for the surface staining composition 100. The acrylic lacquer 110 may be comprised of a combination of ingredients including: Isobutylene Acetate, 2-Methel-1-propanol, Acrylic Polymer, Cellulose Acetate Buterate, Aliphatic Hydrocarbon Solvent, Ethanol, Methyl Ethel Keyone, Methyl n-Amyl Keytone, Xylene, 1-Methoxy-2-Propanol Acetate, and/or Ethelbenzene.

Further, the stain base 120 may be comprised of a combination of ingredients including: Med. Aliphatic Hydrocarbon Solvent, Alkyd Polymer, Umber, Lt. Aliphatic Hydrocarbon Solvent, Amino Polymer, Methyl Ethel Ketone, and/or Ethylbenzene. The combination of ingredients may be used in a combination of weight percentages to achieve the stain base 120 having 1 to 10 ratio of the stain base 120 to the acrylic lacquer 110. The stain base 120 may further comprise the at least one pigment additive 130 with the at least one pigment 130 color-matches the surface-color of the surface 10 and may be provided in a plurality of color variations. One of the color variations may be configured to match the surface 10 comprising the wood.

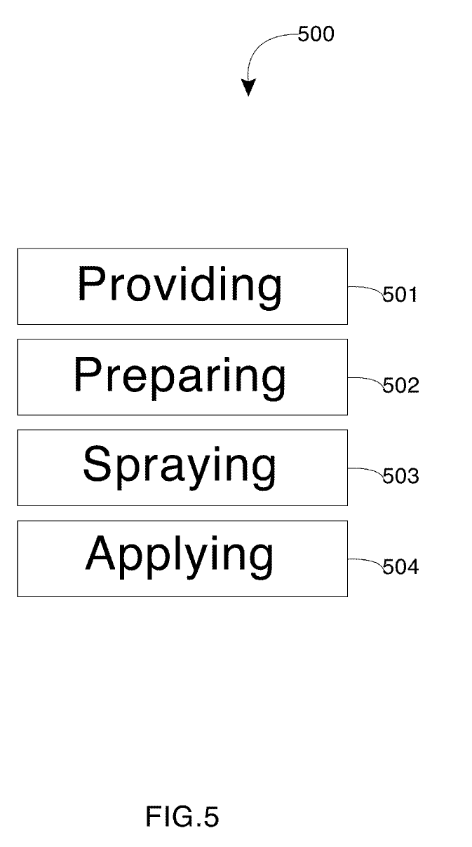

FIG. 5 is a flow diagram illustrating a method for shading a finish coat to a semi-transparent color, according to an embodiment of the present disclosure. In particular, the method for shading the finish coat to the semi-transparent color 500 may include one or more components or features of the surface staining composition 100 as described above. As illustrated, the method for shading the finish coat to the semi-transparent color 500 may include the steps of: step one 501, providing a surface staining composition 100 comprising a mixture including an admixture of 10 parts acrylic lacquer 110 and 1 part stain base 120; step two 502, preparing a surface 10 for application; step three 503, spraying the surface 10 with the surface staining composition 100; and step four 504, applying at least one layer of the surface staining composition 100.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for applying the surface staining composition 100 [NOTE: e.g., different step orders within above-mentioned list, elimination or addition of certain steps, including or excluding certain maintenance steps, etc.], are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A surface staining composition, the surface staining composition comprising:
a mixture including an admixture of;
10 parts acrylic lacquer; and
1 part stain base;
wherein said stain base comprises at least one pigment additive;
wherein said mixture is applied to a surface to provide a clear protective finish;
wherein said at least one pigment color-matches a surface-color of said surface;
and
wherein said surface comprises wood.

2. The surface staining composition of claim 1, wherein said mixture is atomizable and provided in an aerosol can.

3. The surface staining composition of claim 2, wherein said mixture is applied via spraying to said surface.

4. The surface staining composition of claim 3, wherein spraying of said mixture provides a uniform and even color when said mixture is applied to said surface.

5. The surface staining composition of claim 2, wherein said mixture is provided as a liquid, said liquid being distributed in an aerosol mist of liquid-particles via a spray-tip on said aerosol can.

6. The surface staining composition of claim 1, wherein said acrylic lacquer comprises a mixture of Isobutylene Acetate, 2-Methel-1-propanol, Acrylic Polymer, Cellulose Acetate Buterate, Aliphatic Hydrocarbon Solvent, Ethanol, Methyl Ethel Keytone, Methyl n-Amyl Keytone, Xylene, 1-Methoxy-2-Propanol Acetate, and/or Ethelbenzene.

7. The surface staining composition of claim 1, wherein said stain base comprises Med. Aliphatic Hydrocarbon Solvent, Alkyd Polymer, Umber, Lt. Aliphatic Hydrocarbon Solvent, Amino Polymer, Methyl Ethel Ketone, and/or Ethylbenzene.

8. The surface staining composition of claim 1, wherein said stain base of said surface staining composition includes said at least one pigment which is provided in a plurality of color variations.

9. The surface staining composition of claim 8, wherein one of said color variations is configured to match said surface comprising said wood.

10. The surface staining composition of claim 9, wherein said mixture is semi-transparent when applied to said surface.

11. The surface staining composition of claim 1, wherein said surface staining composition is applied in layers.

12. The surface staining composition of claim 11, wherein said surface staining composition when applied, adheres to, and forms a continuous coat on said surface in which said surface staining composition is applied.

13. The surface staining composition of claim 1, further comprises a thickener.

14. The surface staining composition of claim 1, further comprises a binder.

15. The surface staining composition of claim 1, further comprises a thinner.

16. The surface staining composition of claim 1, wherein said acrylic lacquer is a finishing agent.

17. The surface staining composition of claim 1, wherein said mixture comprises an approximately 1 to 10 ratio of said stain base to said acrylic lacquer.

18. A surface staining composition, the surface staining composition comprising:
a mixture including an admixture of;
10 parts acrylic lacquer; and
1 part stain base;
wherein said stain base comprises at least one pigment additive;
wherein said mixture is applied to a surface to provide a clear protective finish;
wherein said at least one pigment color-matches a surface-color of said surface;
wherein said mixture is atomizable and provided in an aerosol can;
wherein said mixture is applied via spraying to said surface;
wherein spraying of said mixture provides a uniform and even color when said mixture is applied to said surface;
wherein said mixture is provided as a liquid, said liquid being distributed in an aerosol mist of liquid-particles via a spray-tip on said aerosol can;
wherein said aerosol can includes an actuator, a valve, and a dip tube configured to be used in combination for distributing said mixture evenly across said surface as emitted;
wherein said surface comprises wood;
wherein said stain base of said surface staining composition includes said at least one pigment which is provided in a plurality of color variations;
wherein one of said color variations is configured to match said surface comprising said wood;
wherein said mixture is semi-transparent when applied to said surface;
wherein said surface staining composition is applied in layers;
wherein said surface staining composition when applied, adheres to, and forms a continuous coat on said surface in which said surface staining composition is applied;
wherein said acrylic lacquer is a finishing agent; and
wherein said mixture comprises an approximately 1 to 10 ratio of said stain base to said acrylic lacquer.

19. The surface staining composition of claim 18, further comprising a surface staining composition provided in an aerosol can, a set of instructions; and
wherein the surface staining composition is arranged as a kit.

20. A method for shading a finish coat to a semi-transparent color, the method comprising the steps of:
providing a surface staining composition comprising;
a mixture including an admixture of;
10 parts acrylic lacquer; and
1 part stain base;
preparing a surface for application;
spraying said surface with said surface staining composition; and
applying at least one layer of said surface staining composition
